(19) United States
(12) Patent Application Publication
(10) Pub. No.: US 2024/0278251 A1
(43) Pub. Date: Aug. 22, 2024

(54) GLASS BREAKING APPARATUS, GLASS PROCESSING SYSTEM, AND GLASS PROCESSING METHOD

(71) Applicant: CORNING INCORPORATED, CORNING, NY (US)

(72) Inventors: EuiHo Kim, Asan-si (KR); Ga-Hyun Kim, Asan-si (KR); Junwoo Kim, Asan-si (KR)

(21) Appl. No.: 18/568,867

(22) PCT Filed: May 26, 2022
(86) PCT No.: PCT/US2022/031010

§ 371 Date: Dec. 11, 2023

(30) Foreign Application Priority Data
Jun. 10, 2021 (KR) 10-2021-0075578

(51) Int. Cl. B02C 4/08; B02C 4/28; B02C 4/30; C03B 33/023; C03B 33/03; C03B 33/09

(52) U.S. Cl. CPC B02C 4/08; B02C 4/286; B02C 4/30; C03B 33/0235; C03B 33/03; C03B 33/091

(57) ABSTRACT

A glass breaking apparatus (10) includes a belt conveyor assembly (100) configured to transfer glass in a first direction, and a breaking roller assembly (200) configured to break the glass received from the belt conveyor assembly, the breaking roller assembly including a first breaking roller (210) including a breaking pin (215) and configured to rotate around a rotation axis extending in a second direction perpendicular to the first direction, and a second breaking roller (220) arranged under the first breaking roller (210), configured to rotate in a direction opposite to a rotation direction of the first breaking roller.

### CROSS-REFERENCE TO RELATED APPLICATIONS

This application claims the benefit of priority under 35 U.S.C. § 119 of Korean Patent Application Serial No. 10-2021-0075578 filed on Jun. 10, 2021, the content of which is relied upon and incorporated herein by reference in its entirety.

### BACKGROUND

### Field

The disclosure is a glass processing system and method of forming a glass roll, and more particularly, to a glass breaking apparatus used in the glass processing system and method.

### Description of the Related Art

Glass having a thin thickness may be bendable and flexible.

The bendable and flexible glass may be used as a material for flexible displays, wearable electronic apparatuses, and building interior and exterior decorations.

The flexible glass may be stored and transported in the form of a glass roll in which glass is wound in a roll shape.

A necessary width of glass may vary according to the use of an end customer.

Accordingly, developments of a system and method of forming a glass roll having a desired width and an apparatus and method of breaking cut glass are necessary.

### SUMMARY

Provided is a system and method of forming a glass roll.

Furthermore, provided is a glass breaking apparatus configured to break glass in the system and method of forming a glass roll.

Additional aspects will be set forth in part in the description which follows and, in part, will be apparent from the description, or may be learned by practice of the presented embodiments of the disclosure.

According to an aspect of the disclosure, a glass breaking apparatus includes a belt conveyor assembly configured to transfer glass in a first direction, and a breaking roller assembly configured to break the glass received from the belt conveyor assembly, the breaking roller assembly including a first breaking roller including a breaking pin and configured to rotate around a rotation axis extending in a second direction perpendicular to the first direction, and a second breaking roller arranged under the first breaking roller, configured to rotate in a direction opposite to a rotation direction of the first breaking roller.

In an embodiment, the glass breaking apparatus may further include a plurality of frames arranged at sides of the belt conveyor assembly and the breaking roller assembly, and configured to fix the belt conveyor assembly and the breaking roller assembly.

In an embodiment, the belt conveyor assembly may include a first conveyor roller arranged between the plurality of frames, a second conveyor roller arranged between the plurality of frames to be closer to the breaking roller assembly that the first conveyor roller is, a conveyor belt surrounding the first conveyor roller and the second conveyor roller and including a transfer surface in contact with the glass, and a conveyor motor configured to rotate at least one of the first conveyor roller or the second conveyor roller.

In an embodiment, the first breaking roller may be arranged above the transfer surface of the conveyor belt, the second breaking roller may be arranged under the transfer surface of the conveyor belt, and the first breaking roller and the second breaking roller may be rotated to move the glass in the first direction, the glass passing between the first breaking roller and the second breaking roller.

In an embodiment, the first breaking roller may include a first rotation body including a coupling opening for fit-coupling a portion of the breaking pin, and the coupling opening may extend in a direction parallel to a direction in which a rotation axis of the first rotation body extends.

In an embodiment, the breaking pin may include a coupling portion fit-coupled to the coupling opening of the first rotation body, a breaking portion provided in a tapered shape such that a cross-sectional area of the breaking portion decreases as it is farther away from the coupling portion, and a connection portion configured to connect the coupling portion to the breaking portion.

In an embodiment, a section of the breaking portion may have at least one of a triangular shape, a trapezoidal shape, or a semi-circular shape.

In an embodiment, the first rotation body of the first breaking roller may include a fastening hole passing through at least a portion of the first rotation body in the coupling opening, and the coupling portion of the breaking pin may include a fastening hole overlapping the fastening hole of the first rotation body.

In an embodiment, the glass breaking apparatus may further include a fastening member arranged in the fastening hole of the first rotation body by passing through the fastening hole of the breaking pin, and configured to fix the breaking pin on the first rotation body.

In an embodiment, the second breaking roller may include a second rotation body including the accommodation groove for accommodating the breaking pin, and the accommodation groove may extend in a direction parallel to a direction in which a rotation axis of the second rotation body extends.

In an embodiment, the accommodation groove may have a cross-sectional area that decreases closer to the rotation axis of the second rotation body.

In an embodiment, the glass breaking apparatus may further include a first gear connected to the first breaking roller and arranged outside the frame, a second gear connected to the second breaking roller and arranged outside the frame to be engaged with the first gear, a driving gear connected to at least one of the first gear or the second gear, and a breaking roller motor configured to operate the driving gear.

According to another aspect of the disclosure, a glass processing system include a glass supply apparatus configured to supply glass, a glass cutting apparatus configured to separate the glass into cut glass and residual glass, a glass winding apparatus configured to wind the cut glass to form a glass roll, and a glass breaking apparatus configured to break the residual glass, the glass breaking apparatus including: a belt conveyor assembly configured to transfer the residual glass in a first direction; and a breaking roller assembly configured to break the residual glass received from the belt conveyor assembly, wherein the breaking roller assembly includes a first breaking roller configured to rotate around a rotation axis extending in a second direction perpendicular to the first direction, and including a breaking pin, and a second breaking roller arranged under the first breaking roller, configured to rotate in a direction opposite to a rotation direction of the first breaking roller, and including an accommodation groove for accommodating the breaking pin.

In an embodiment, the glass supply apparatus may include a glass unwinder configured to unwind the glass from an initial glass roll.

In an embodiment, the glass cutting apparatus may include a laser configured to irradiate a laser beam onto the glass.

In an embodiment, the glass breaking apparatus may further include a plurality of frames arranged at sides of the belt conveyor assembly and the breaking roller assembly, and configured to fix the belt conveyor assembly and the breaking roller assembly.

In an embodiment, the belt conveyor assembly may include a first conveyor roller arranged between the plurality of frames, a second conveyor roller arranged between the plurality of frames to be closer to the breaking roller assembly than the first conveyor roller is, a conveyor belt surrounding the first conveyor roller and the second conveyor roller, and including a transfer surface in contact with the glass, and a conveyor motor configured to rotate at least one of the first conveyor roller or the second conveyor roller.

In an embodiment, the first breaking roller may be arranged above the transfer surface of the conveyor belt, and the second breaking roller may be arranged under the transfer surface of the conveyor belt.

In an embodiment, the first breaking roller may include a first rotation body including a coupling opening for fit-coupling a portion of the breaking pin, and the coupling opening may extend in a direction parallel to a direction in which a rotation axis of the first rotation body extends.

In an embodiment, the breaking pin may include a coupling portion fit-coupled to the coupling opening of the first rotation body, a breaking portion provided in a tapered shape such that a cross-sectional area of the breaking portion decreases as it is farther away from the coupling portion, and a connection portion configured to connect the coupling portion to the breaking portion.

In an embodiment, the first rotation body of the first breaking roller may include a fastening hole passing through at least a portion of the first rotation body in the coupling opening, and the coupling portion of the breaking pin may include a fastening hole overlapping the fastening hole of the first rotation body.

In an embodiment, the glass breaking apparatus may further include a fastening member arranged in the fastening hole of the first rotation body by passing through the fastening hole of the breaking pin, and configured to fix the breaking pin on the first rotation body.

In an embodiment, the second breaking roller may include a second rotation body including the accommodation groove for accommodating the breaking pin, and the accommodation groove may extend in a direction parallel to a direction in which a rotation axis of the second rotation body extends.

In an embodiment, a diameter of a section of the first breaking roller and a diameter of a section of the second breaking roller each may be about 30 millimeters to about 70 millimeters.

According to an aspect of the disclosure, a glass processing method include transferring residual glass in a first direction through a conveyor belt assembly, and breaking the residual glass while transferring the residual glass received from the conveyor belt assembly in the first direction.

In an embodiment, the breaking of the residual glass may include providing the residual glass between a first breaking roller arranged above the residual glass and including a breaking pin configured to break the residual glass, and a second breaking roller arranged under the residual glass and including an accommodation groove for accommodating the breaking pin, and transferring the residual glass the in the first direction through rotations of the first breaking roller and the second breaking roller and simultaneously breaking the residual glass through the breaking pin.

In an embodiment, the glass processing method may further include unwinding glass from an initial glass roll, cutting the glass to separate the glass into cut glass and the residual glass, and winding the cut glass.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a glass breaking apparatus according to an embodiment;

FIG. 2 is a view of a belt conveyor assembly according to an embodiment;

FIG. 3 is a perspective view of a breaking roller assembly according to an embodiment;

FIG. 4 is a perspective view of a first breaking roller according to an embodiment;

FIG. 5 is a plan view of a first breaking roller from which a breaking pin is separated, according to an embodiment;

FIG. 6 is a perspective view of a breaking pin according to an embodiment;

FIG. 7 is a view of a breaking portion of the breaking pin, according to an embodiment;

FIG. 8 is an exploded perspective view of a first breaking roller according to an embodiment;

FIG. 9 is a perspective view of a second breaking roller according to an embodiment;

FIGS. 10 and 11 are perspective views of operations of a glass breaking process by using a glass breaking apparatus, according to an embodiment;

FIG. 12 is a view of a glass processing system according to an embodiment;

FIG. 13 is a view of operations of a glass supply apparatus, a glass cutting apparatus, and a glass winding apparatus of the glass processing system of FIG. 12;

FIG. 14 is a view of an operation of a glass breaking apparatus of the glass processing system of FIG. 12; and

FIGS. 15 and 16 are flowcharts of glass processing methods according to embodiments.

### DETAILED DESCRIPTION

Reference will now be made in detail to embodiments, examples of which are illustrated in the accompanying drawings, wherein like reference numerals refer to like elements throughout.

In this regard, the present embodiments may have different forms and should not be construed as being limited to the descriptions set forth herein.

Accordingly, the embodiments are merely described below, by referring to the figures, to explain aspects of the present description.

As used herein, the term “and/or” includes any and all combinations of one or more of the associated listed items.

Expressions such as “at least one of,” when preceding a list of elements, modify the entire list of elements and do not modify the individual elements of the list.

The disclosure will now be described more fully with reference to the accompanying drawings, in which embodiments of the disclosure are shown.

The disclosure may, however, be embodied in many different forms and should not be construed as being limited to the embodiments set forth herein;

rather, these embodiments are provided so that this disclosure will be thorough and complete, and will fully convey the concept of the disclosure to those of ordinary skill in the art.

Like reference numerals in the drawings denote like elements.

Furthermore, various elements and areas are schematically illustrated in the drawings.

Accordingly, the concept of the disclosure is not limited by relatively sizes or intervals illustrated in the accompanying drawings.

Terms such as “first” and “second” are used herein merely to describe a variety of constituent elements, but the constituent elements are not limited by the terms.

Such terms are used only for the purpose of distinguishing one constituent element from another constituent element.

For example, without departing from the right scope of the disclosure, a first constituent element may be referred to as a second constituent element, and vice versa.

Terms used in the specification are used for explaining a specific embodiment, not for limiting the disclosure.

Thus, an expression used in a singular form in the specification also includes the expression in its plural form unless clearly specified otherwise in context.

Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain.

The terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order.

For example, two consecutively described processes may be performed substantially at the same time or performed in an order opposite to the described order.

In the accompanying drawings, variations from the shapes of the illustrations as a result, for example, of manufacturing techniques and/or tolerances, are to be expected.

Thus, the embodiment of the disclosure may not be construed to be limited to a particular shape of a part described in the specification and may include a change in the shape generated during manufacturing, for example.

As used herein, the term “and/or” includes any and all combinations of one or more of the associated listed items.

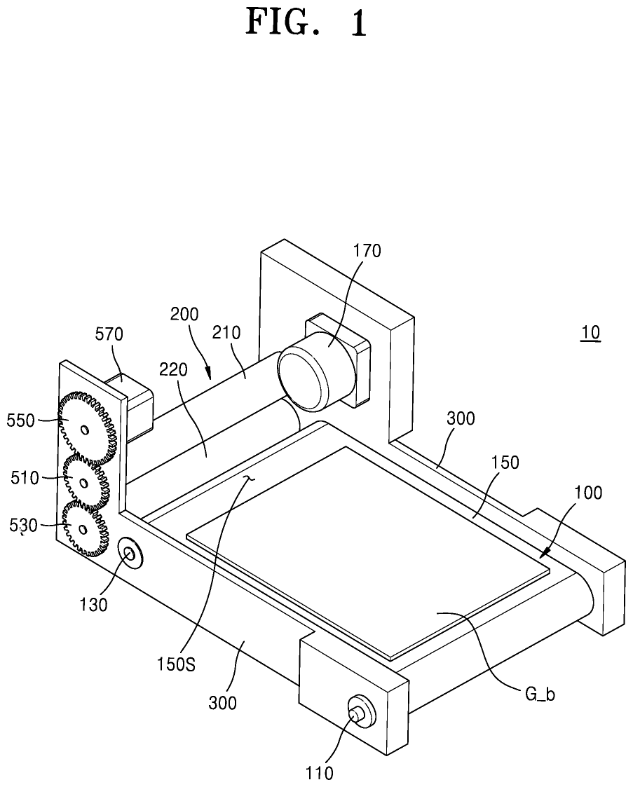

FIG. 1 is a perspective view of a glass breaking apparatus 10 according to an embodiment.

The glass breaking apparatus 10 according to an embodiment may be configured to break the glass G_b while moving glass G_b in a first direction.

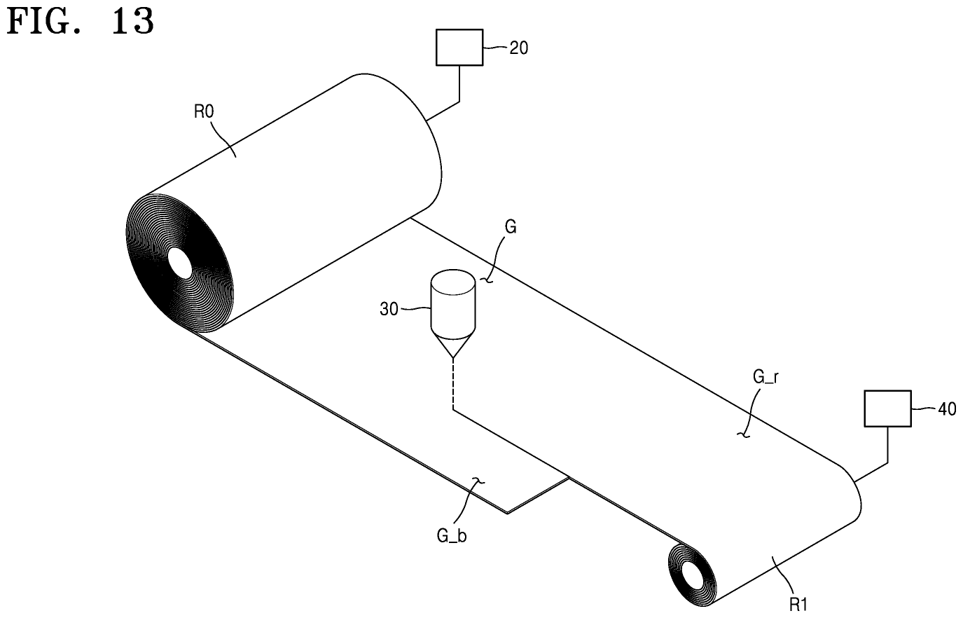

In detail, glass G of FIG. 13 may be cut to a necessary width according to according to the use of an end customer.

Cut glass G_r of FIG. 13 that is cut to a necessary width may be stored and transported in the form of a glass roll, and residual glass G_b of FIG. 13 remaining after a cutting process may be broken.

The glass breaking apparatus 10 according to an embodiment may be an apparatus configured to break the residual glass G_b remaining after the cutting process of the glass G.

In the following description, for convenience of explanation of the disclosure with reference to FIGS. 1 to 11, the residual glass G_b may be referred to as the glass G_b.

In an embodiment, the glass G_b may be thin and flexible glass. In addition, the thickness of the glass G_b may be much smaller than the width of the glass G_b and the length of the glass G_b in the first direction.

For example, the thickness of the glass G_b may be less than about 1 millimeter. Specifically, the thickness of the glass G_b may be about 30 micrometers to about 300 micrometers.

Referring to FIG. 1, the glass breaking apparatus 10 according to an embodiment may include a belt conveyor assembly 100 configured to move the glass G_b in the first direction, a breaking roller assembly 200 configured to break the glass G_b received from the belt conveyor assembly 100, and a plurality of frames 300 configured to fix the belt conveyor assembly 100 and the breaking roller assembly 200.

In an embodiment, the belt conveyor assembly 100 may be configured to move the glass G_b in the first direction.

The first direction may be substantially the same direction as a direction in which a transfer surface 150S is moved, the transfer surface 150S being one in contact with the glass G_b among surfaces of a conveyor belt 150 of the belt conveyor assembly 100.

The belt conveyor assembly 100 may include a first conveyor roller 110, a second conveyor roller 130, the conveyor belt 150, and a conveyor motor 170.

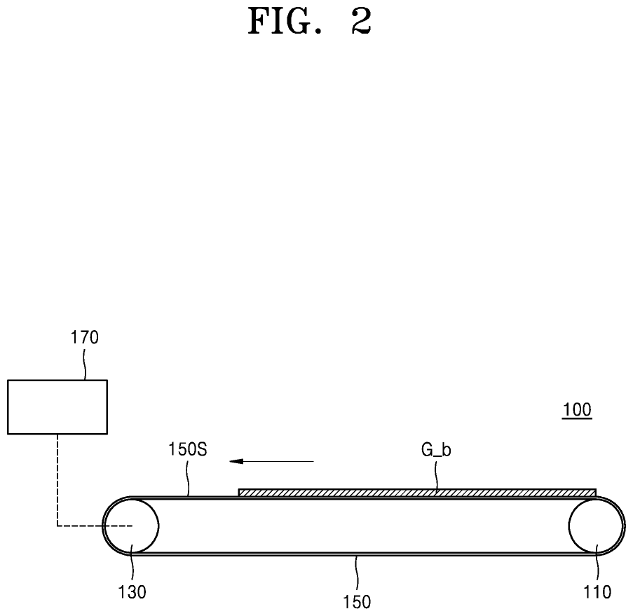

The technical concept related to the constituent elements of the belt conveyor assembly 100 may be described in detail with reference to FIG. 2.

In an embodiment, the breaking roller assembly 200 may be arranged at the rear of the belt conveyor assembly 100, and configured to break the glass G_b received from the belt conveyor assembly 100.

In detail, the breaking roller assembly 200 may be configured to move the glass G_b in the first direction and simultaneously break the glass G_b.

A glass breaking apparatus according to a comparative example may include a glass transfer apparatus configured to transfer glass in the first direction and a breaking assembly arranged above the glass transfer apparatus and configured to move in a second direction perpendicular to the first direction and break the glass by chopping an upper surface of the glass.

When the breaking assembly of the glass breaking apparatus according to a comparative example moves in the second direction and breaks the glass by chopping the upper surface of the glass, the glass may be moved in a direction opposite to the first direction, that is, in a direction opposite to a movement direction of the glass, due to an external force applied by the breaking assembly.

In this case, yield of a glass breaking process using the glass breaking apparatus according to a comparative example may be reduced.

The breaking roller assembly 200 according to an embodiment may be configured to move the glass G_b in the first direction and break the glass G_b.

Accordingly, in the glass breaking process using the breaking roller assembly 200, the glass G_b may not be moved in a direction opposite to the first direction, and the yield of the glass breaking process may be increased.

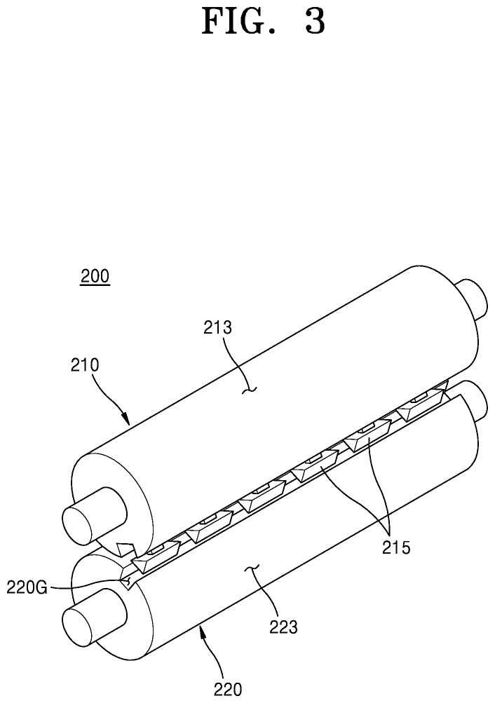

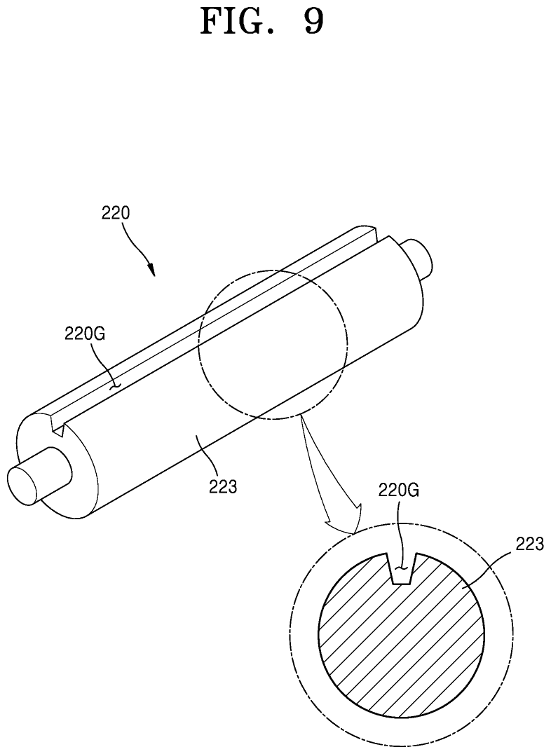

The breaking roller assembly 200 may include a first breaking roller 210 including a breaking pin 215 of FIG. 3 and configured to rotate in a first rotation direction and a second breaking roller 220 including an accommodation groove 220G of FIG. 9 for accommodating the breaking pin 215 and configured to rotate in a second rotation direction opposite to the first rotation direction so that the accommodation groove 220G is engaged with the breaking pin 215.

The technical concept related to the constituent elements of the breaking roller assembly 200 is described in detail with reference to FIGS. 3 to 11.

The frames 300 may be arranged at the sides of the belt conveyor assembly 100 and the breaking roller assembly 200, and configured to fix the belt conveyor assembly 100 and the breaking roller assembly 200.

FIG. 2 is a view of the belt conveyor assembly 100 according to an embodiment.

The belt conveyor assembly 100 according to an embodiment may be configured to transfer the glass G_b in the first direction.

In detail, the belt conveyor assembly 100 may be an apparatus configured to break the residual glass G_b remaining after the cutting process of the glass G.

Referring to FIG. 2, the belt conveyor assembly 100 may include the first conveyor roller 110, the second conveyor roller 130, the conveyor belt 150, and the conveyor motor 170.

The first conveyor roller 110 may be arranged between the frames 300.

Furthermore, the second conveyor roller 130 may be arranged between the frames 300 to be closer to the breaking roller assembly 200 than the first conveyor roller 110 is.

For example, the first conveyor roller 110 and the second conveyor roller 130 may be configured to rotate substantially in the same rotation direction.

The conveyor belt 150 may surround the first conveyor roller 110 and the second conveyor roller 130.

Furthermore, the conveyor belt 150 may be configured to rotate in substantially the same direction as the rotation direction of the first conveyor roller 110 and the second conveyor roller 130 by the rotation of the first conveyor roller 110 and the second conveyor roller 130.

The conveyor belt 150 may have the transfer surface 150S in contact with the glass G_b, and the transfer surface 150S may be an upper surface of the conveyor belt 150.

The conveyor motor 170 may be configured to rotate at least one of the first conveyor roller 110 or the second conveyor roller 130.

For example, the conveyor motor 170 may be rotatable and may provide a rotation force at least one of the first conveyor roller 110 or the second conveyor roller 130 through a combination of gears.

FIGS. 3 to 9 are views of the breaking roller assembly 200 according to an embodiment.

In detail, FIG. 3 is a perspective view of the breaking roller assembly 200 according to an embodiment.

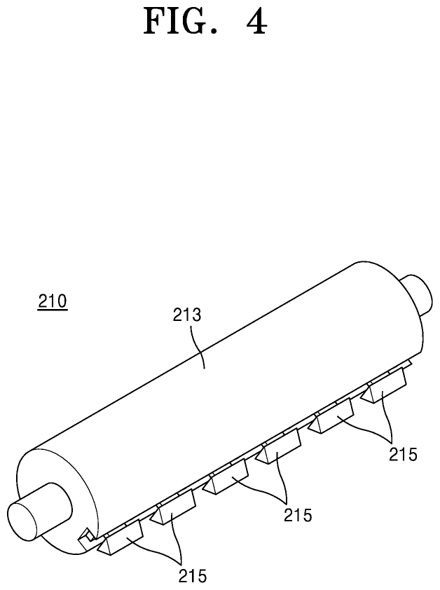

FIG. 4 is a perspective view of a first breaking roller 210 according to an embodiment.

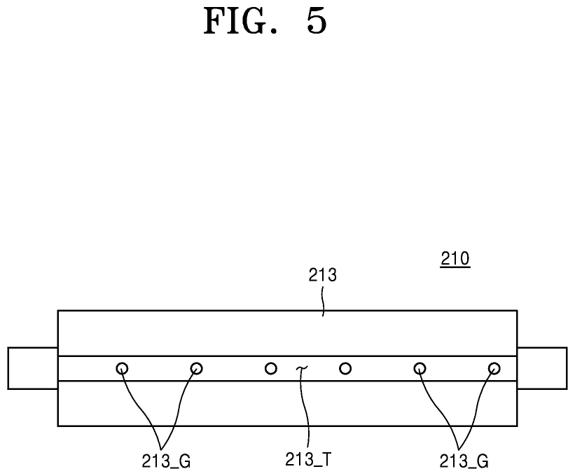

FIG. 5 is a plan view of the first breaking roller 210 from which the breaking pin 215 is separated, according to an embodiment.

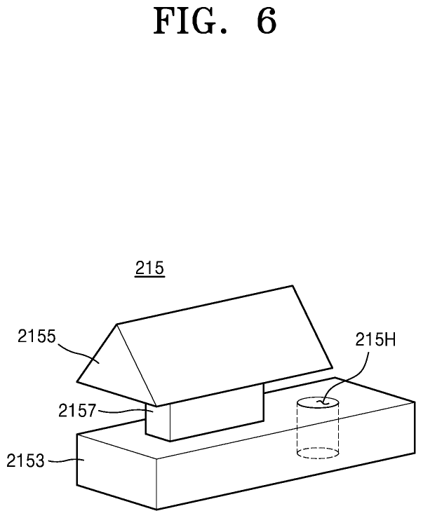

FIG. 6 is a perspective view of the breaking pin 215 according to an embodiment.

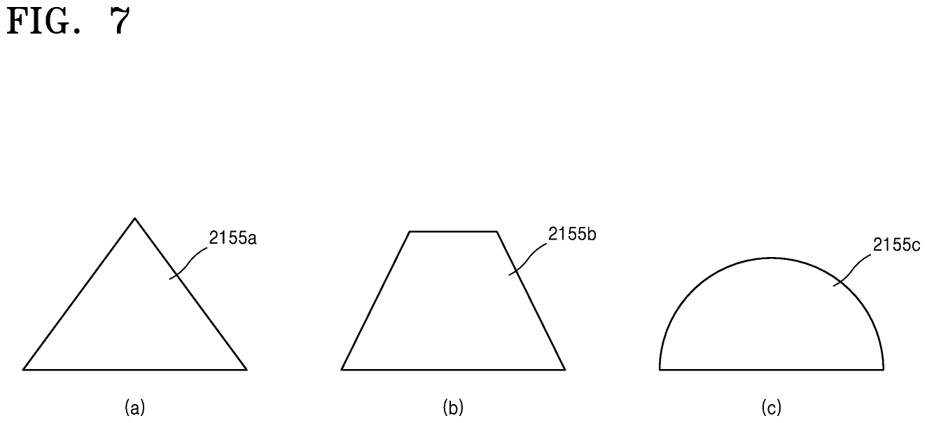

FIG. 7 is a view of a breaking portion 2155 of the breaking pin 215, according to an embodiment;

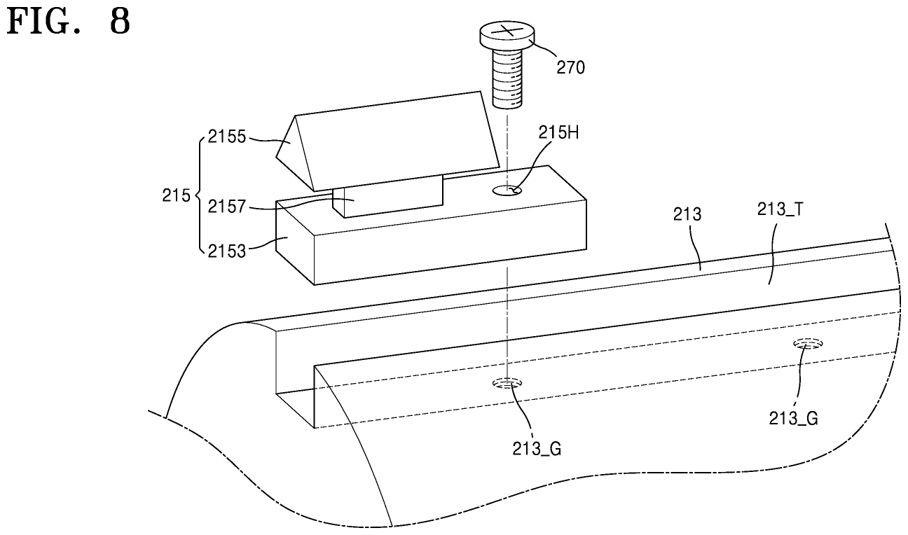

FIG. 8 is an exploded perspective view of the first breaking roller 210 according to an embodiment.

Furthermore, FIG. 9 is a perspective view of the second breaking roller 220 according to an embodiment.

In the following description, the breaking roller assembly 200 according to an embodiment is described in detail with reference to FIGS. 3 to 9.

Referring to FIG. 3, a the breaking roller assembly 200 according to an embodiment may be arranged at the rear of the belt conveyor assembly 100, and configured to break the glass G_b received from the belt conveyor assembly 100.

In detail, the breaking roller assembly 200 may be configured to move the glass G_b in the first direction and simultaneously break the glass G_b.

The breaking roller assembly 200 may include the first breaking roller 210 including the breaking pin 215 and the second breaking roller 220 including the accommodation groove 220G for accommodating the breaking pin 215.

In an embodiment, the first breaking roller 210 including the breaking pin 215 may be configured to rotate in the first rotation direction.

Furthermore, the second breaking roller 220 may be arranged under the first breaking roller 210, and configured to rotate in the second rotation direction opposite to the first rotation direction.

In an embodiment, the first breaking roller 210 and the second breaking roller 220 may be rotated by being engaged with each other so that the lowermost portion of the first breaking roller 210 and the uppermost portion of the second breaking roller 220 move in the first direction.

In an embodiment, the first breaking roller 210 may be arranged above the transfer surface 150S of the conveyor belt 150, and the second breaking roller 220 may be arranged under the transfer surface 150S of the conveyor belt 150.

In other words, a level of the transfer surface 150S of the conveyor belt 150 may be between a level of the lowermost portion of the first breaking roller 210 and a level of the upper most portion of the second breaking roller 220.

Accordingly, the glass G_b carried out from the conveyor belt 150 may enter between the first breaking roller 210 and the second breaking roller 220, and may be broken while moving in the first direction through the rotations of the first breaking roller 210 and the second breaking roller 220.

In an embodiment, referring to FIG. 1, the glass breaking apparatus 10 may include a first gear 510 connected to the first breaking roller 210 and arranged outside the frames 300, a second gear 530 connected to the second breaking roller 220 and arranged outside the frames 300 to be engaged with the first gear 510, and a driving gear 550 connected to at least one of the first gear 510 or the second gear 530 and arranged outside the frames 300.

Furthermore, the glass breaking apparatus 10 may include a breaking roller motor 570 configured to operate the driving gear 550.

The first gear 510 and the second gear 530 may be configured to rotate by being engaged with each other as the breaking roller motor 570 operates the driving gear 550.

Furthermore, as the first gear 510 and the second gear 530 rotate, the first breaking roller 210 and the second breaking roller 220 are rotated to move the glass G_b in the first direction and break the glass G_b.

In the following description, referring to FIGS. 4 to 8, the first breaking roller 210 according to an embodiment is described in detail.

The first breaking roller 210 according to an embodiment may include a first rotation body 213 and the breaking pin 215.

Referring to FIGS. 4 and 5 together, the first rotation body 213 may have a cylindrical shape.

Furthermore, the first rotation body 213 may have a coupling opening 213_T that extends in a direction parallel to a direction, in which the first rotation body 213 extends, for fit coupling of a portion of the breaking pin 215.

Furthermore, the first rotation body 213 may have a plurality of fastening holes 213_G that are arranged to pass through at least a portion of the first rotation body 213 in the coupling opening 213_T and extend in a direction parallel to a direction in which the first rotation body 213.

In an embodiment, the breaking pin 215 may be fit-coupled to the coupling opening 213_T of the first rotation body 213 to be primarily fixed to the first rotation body 213.

Furthermore, the breaking pin 215 may be secondarily fixed to the first rotation body 213 by using a fastening member 270 of FIG. 8 that passes through a fastening hole 215H of FIG. 6 of the breaking pin 215 and the fastening holes 213_G of the first rotation body 213.

In an embodiment, the fastening holes 213_G may include a plurality of fastening holes.

Accordingly, a separation distance between the breaking pins 215 may be freely adjusted.

Furthermore, various types of the breaking pins 215 may be coupled to or separated from the first rotation body 213, as necessary.

For example, the breaking pins 215 including the breaking portion 2155 of FIG. 6 provided in various shapes and sizes the breaking pins 215 may be coupled to or separated from the first rotation body 213, as necessary.

In an embodiment, when the first rotation body 213 is cut in a direction perpendicular to a rotation axis thereof, the diameter of a section of the first rotation body 213 may be about 30 millimeters to about 70 millimeters.

Referring to FIGS. 6 to 8 together, the breaking pin 215 may include a coupling portion 2153, the breaking portion 2155, and a connection portion 2157.

In an embodiment, the coupling portion 2153 of the breaking pin 215 [symbol] a portion of the breaking pin 215 that is fit-coupled to the coupling opening 213_T of the first rotation body 213.

In an embodiment, the shape of a section of the coupling portion 2153 of the breaking pin 215 may be the shape of a section of the coupling opening 213_T of the first rotation body 213.

For example, when the section of the coupling opening 213_T of the first rotation body 213 has a triangular shape, the section of the coupling portion 2153 of the breaking pin 215 may have a triangular shape.

In an embodiment, the coupling portion 2153 of the breaking pin 215 may have a fastening hole 215H that overlaps the fastening hole 213_G of the first rotation body 213 in a vertical direction.

The fastening hole 215H of the breaking pin 215 and the fastening hole 213_G of the first rotation body 213 may provide a space in which a fastening member 270 is arranged.

Furthermore, the breaking pin 215 may be coupled to the first rotation body 213 by the fastening member 270 that passes through the fastening hole 215H and the fastening hole 213_G.

In an embodiment, the breaking portion 2155 of the breaking pin 215 may be in contact with the glass G_b in the glass breaking process, and may be a portion of the breaking pin 215 configured to break the glass G_b.

In an embodiment, the breaking portion 2155 may be arranged above the coupling portion 2153.

Furthermore, the breaking portion 2155 may have a tapered shape such that a cross-sectional area of the breaking portion 2155 in a horizontal direction decreases as it is farther away from the coupling portion 2153, that is, closer to the glass G_b.

Referring to FIG. 7(a), the section of the breaking portion 2155 may have a triangular shape 2155a.

For example, the section of the breaking portion 2155 may have an acute triangular shape.

Furthermore, referring to FIG. 7(b), the section of the breaking portion 2155 may have a trapezoidal shape 2155b in which the length of an upper side is less than the length of a lower side.

Furthermore, referring to FIG. 7(c), the section of the breaking portion 2155 may have a semi-circular shape 2155c.

However, the shape of the section of the breaking portion 2155 is not limited to the above descriptions.

In an embodiment, the connection portion 2157 may be a portion of the breaking pin 215 configured to connect the coupling portion 2153 to the breaking portion 2155.

For example, the connection portion 2157 may be a post arranged between the coupling portion 2153 and the breaking portion 2155.

The connection portion 2157 may have a cuboidal or cylindrical shape.

However, the shape of the connection portion 2157 is not limited to the above descriptions.

In an embodiment, the glass breaking apparatus 10 may further include the fastening member 270 configured to couple the breaking pin 215 to the first rotation body 213.

In an embodiment, the fastening member 270 may be configured to couple the breaking pin 215 to the first rotation body 213 by passing through the fastening hole 215H of the breaking pin 215 and the fastening hole 213_G of the first rotation body 213.

The breaking pin 215 according to an embodiment may be separated from or coupled to the first rotation body 213.

Accordingly, the breaking pin 215 including the breaking portion 2155 provided in various sizes and shapes may be coupled to the first rotation body 213 according to the user's convenience.

In other words, any one of the breaking pins 215 including the breaking portion 2155 provided in various sizes and shapes may be determined according to the type and thickness of the glass G_b to be broken.

Referring to FIG. 9, the second breaking roller 220 may be arranged under the first breaking roller 210, and configured to rotate in a direction opposite to a rotation direction of the first breaking roller 210.

In an embodiment, the second breaking roller 220 may include a second rotation body 223, and the accommodation groove 220G provided to a portion of the second rotation body 223 and accommodating the breaking pin 215 of the first breaking roller 210.

The first breaking roller 210 and the second breaking roller 220 may rotate such that the accommodation groove 220G of the second breaking roller 220 is engaged with the breaking pin 215 of the first breaking roller 210.

In an embodiment, the accommodation groove 220G of the second breaking roller 220 may be provided to extend in a direction in which the second rotation body 223 extends.

For example, as the breaking pin 215 of the first breaking roller 210 extends in a direction in which the rotation axis of the first rotation body 213 extends, the accommodation groove 220G of the second breaking roller 220 for accommodating the breaking pin 215 may extend in a direction in which a rotation axis of the second rotation body 223 extends.

Furthermore, a section of the accommodation groove 220G may be provided in a shape corresponding to the section of the breaking portion 2155 of the breaking pin 215 of the first breaking roller 210.

For example, when the breaking portion 2155 of the breaking pin 215 has a shape such that a cross-sectional area of the breaking portion 2155 decreases as it is farther away from the rotation axis of the first rotation body 213, the accommodation groove 220G of the second breaking roller 220 may have a shape such that a cross-sectional area of the accommodation groove 220G decreases as it is closer to the rotation axis of the second rotation body 223.

In an embodiment, when the second rotation body 223 is cut in a direction perpendicular to the rotation axis thereof, the diameter of a section of the second rotation body 223 may be about 30 millimeters to about 70 millimeters.

In an embodiment, when the second breaking roller 220 is cut in a direction perpendicular to the rotation axis thereof, the section of the accommodation groove 220G of the second breaking roller 220 may have at least one of an inverse-triangular shape, an inverse-trapezoidal shape, or an inverse-semi-circular shape.

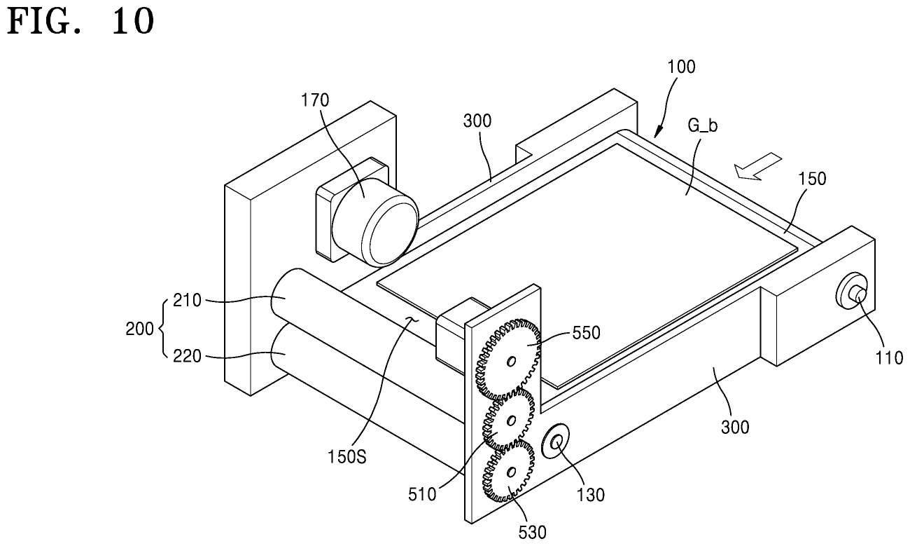

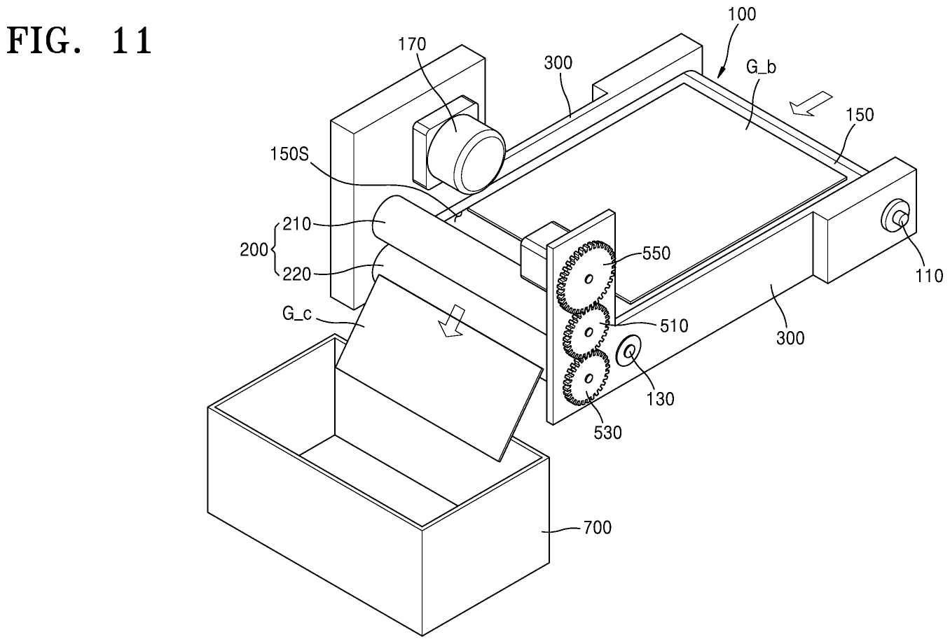

FIGS. 10 and 11 are perspective views of operations of a glass breaking process by using the glass breaking apparatus 10, according to an embodiment.

A glass breaking process using the glass breaking apparatus 10 according to an embodiment may include moving the glass G_b in the first direction through the belt conveyor assembly 100, and moving the glass G_b received from the belt conveyor assembly 100 in the first direction through the breaking roller assembly 200 and simultaneously breaking the glass G_b.

Referring to FIG. 10, the glass G_b may be placed on the transfer surface 150S of the conveyor belt 150 of the belt conveyor assembly 100.

Furthermore, the glass G_b may be moved in the first direction through the rotations of the first conveyor roller 110 and the second conveyor roller 130.

Referring to FIG. 11, the glass G_b may enter a space between the first breaking roller 210 and the second breaking roller 220.

In detail, as the first breaking roller 210 may be arranged above the transfer surface 150S of the conveyor belt 150 and the second breaking roller 220 may be arranged under the transfer surface 150S of the conveyor belt 150, the glass G_b may enter the space between the first breaking roller 210 and the second breaking roller 220.

The glass G_b may be provided between a lower surface of the first breaking roller 210 and an upper surface of the second breaking roller 220, and the glass G_b may be moved in the first direction through the rotations of the first breaking roller 210 and the second breaking roller 220.

Furthermore, while the breaking roller assembly 200 moves the glass G_b in the first direction, the breaking roller assembly 200 may break the glass G_b.

In an embodiment, when the breaking pin 215 of the first breaking roller 210 is in contact with the glass G_b through the rotation of the first rotation body 213, the breaking pin 215 may break the glass G_b.

Broken glass G_c that is broken by the breaking roller assembly 200 may fall downward by gravity by passing between the first breaking roller 210 and the second breaking roller 220.

The broken glass G_c that fell may be contained in a container 700 arranged under the breaking roller assembly 200.

The breaking assembly of the glass breaking apparatus according to a comparative example may move in the second direction perpendicular to the first direction that is a direction in which glass is moved, and break the glass by chopping the upper surface of the glass.

In this state, the glass may be moved in a direction opposite to the first direction, that is, in a direction opposite to a movement direction of the glass, due to an external force applied by the breaking assembly.

In this case, yield of a glass breaking process using the glass breaking apparatus according to a comparative example may be reduced.

The breaking roller assembly 200 of the glass breaking apparatus 10 according to an embodiment may be configured to move the glass G_b in the first direction and break the glass G_b.

Accordingly, in the glass breaking process, the glass G_b may not be moved in a direction opposite to the first direction, and the yield of the glass breaking process may be increased.

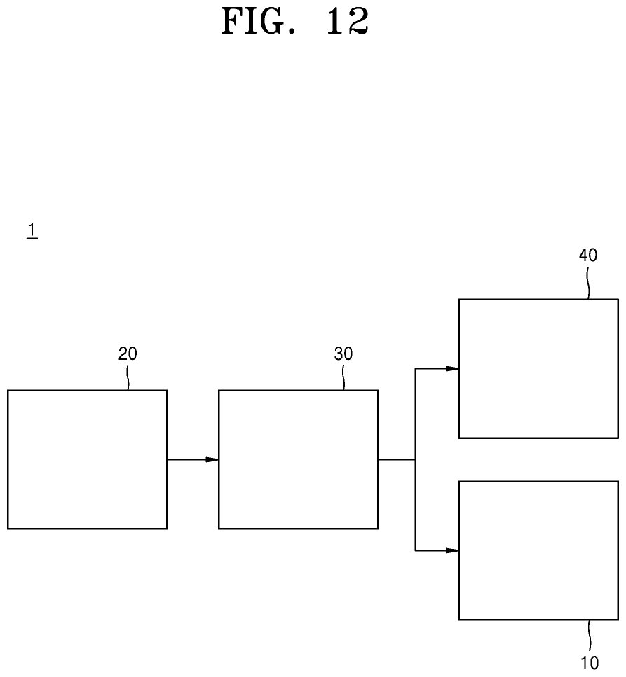

FIG. 12 is a view of a glass processing system 1 according to an embodiment.

FIG. 13 is a view of operations of a glass supply apparatus 20, a glass cutting apparatus 30, and a glass winding apparatus 40 of the glass processing system 1 of FIG. 12.

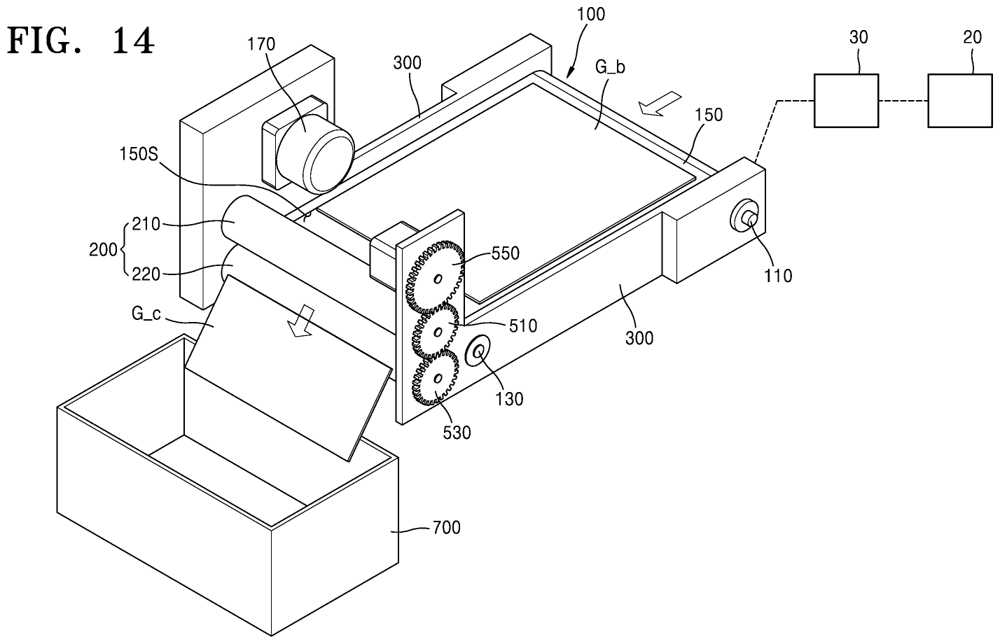

Furthermore, FIG. 14 is a view of an operation of the glass breaking apparatus 10 of the glass processing system 1 according to an embodiment.

Referring to FIG. 12, the glass processing system 1 according to an embodiment may include the glass supply apparatus 20, the glass cutting apparatus 30, the glass winding apparatus 40, and the glass breaking apparatus 10.

The glass processing system 1 according to an embodiment may be a system configured to cut the glass G to a necessary width according to the use of an end customer, form the cut glass G_r in the form of a glass roll, and break the residual glass G_b that remains after the cutting.

In detail, the glass processing system 1 may be a system that performs a roll-to-roll process of providing the glass G by unwinding an initial glass roll R0, cutting the glass G to a necessary width according to the use of an end customer, and forming a new glass roll R1 by winding the cut glass G_r.

In an embodiment, the glass G may be thin and flexible glass. In addition, the thickness of the glass G may be much smaller than the width of the glass G and the length of the glass G in the first direction.

For example, the thickness of the glass G may be less than about 1 millimeter. Specifically, the thickness of the glass G may be about 30 micrometers to about 300 micrometers.

Furthermore, the glass processing system 1 may further perform an operation of breaking the residual glass G_b.

Referring to FIGS. 12 and 13 together, the glass supply apparatus 20 may be configured to supply the glass G.

In detail, the glass supply apparatus 20 may be configured to supply the glass G having a plate shape by unwinding the initial glass roll R0.

In an embodiment, the glass supply apparatus 20 may include a glass unwinder configured to unwind the glass G from the initial glass roll R0.

However, the type of the glass supply apparatus 20 is not limited to the above-described glass unwinder.

An edge of the glass G unwound from the initial glass roll R0 may have an initial defect such as a crack.

Accordingly, when the glass G is processed or used as it is, an additional subsequent defect may be generated from the initial defect.

Accordingly, a portion of the edge of the glass G unwound from the initial glass roll R0 may be removed.

The glass cutting apparatus 30 may be configured to remove a portion of the edge of the glass G having an initial defect and cut the glass G to a necessary width according to the use of an end customer.

In an embodiment, the glass cutting apparatus 30 may include a laser configured to irradiate a laser beam onto the glass G.

In an embodiment, the glass cutting apparatus 30 may be configured to cut the glass G into the cut glass G_r and the residual glass G_b.

For example, the glass cutting apparatus 30 may include a laser configured to heat the glass G by irradiating a laser beam onto the glass G.

For example, the laser may include a CO₂ laser.

In an embodiment, the glass cutting apparatus 30 may further include optical elements to modify a laser beam.

For example, the glass cutting apparatus 30 may further include a polarizer, a beam expander, and a beam shaping apparatus.

Furthermore, the glass cutting apparatus 30 may further include a mirror.

Furthermore, the glass cutting apparatus 30 may further include a cooling apparatus configured to cool a portion of the glass G that is heated by an irradiated laser beam.

The cooling apparatus may be configured to supply, for example, a coolant, to a surface of the glass G.

The coolant may include a liquid, a gas, or a combination thereof, for example, water.

The cut glass G_r generated through the glass cutting apparatus 30 may be moved to the glass winding apparatus 40 to form the new glass roll R1, and the residual glass G_b may be moved to the glass breaking apparatus 10 for breaking.

In an embodiment, the glass winding apparatus 40 may be configured to provide the new glass roll R1 by winding the cut glass G_r.

For example, the glass winding apparatus 40 may be a glass winder configured to wind the cut glass G_r.

Referring to FIGS. 12 and 14, the glass breaking apparatus 10 according to an embodiment may be configured to break the residual glass G_b that remains after the cutting by the glass cutting apparatus 30.

As the technical concept related to the glass breaking apparatus 10 is redundant to the descriptions presented above with reference to FIGS. 1 to 11, detailed descriptions thereof are omitted.

The glass breaking apparatus 10 according to an embodiment may include the belt conveyor assembly 100 configured to move the residual glass G_b in the first direction, the breaking roller assembly 200 configured to break the residual glass G_b received from the belt conveyor assembly 100, and the frames 300 configured to fix the belt conveyor assembly 100 and the breaking roller assembly 200.

Furthermore, the belt conveyor assembly 100 may include the first conveyor roller 110 arranged between the frames 300, the second conveyor roller 130 arranged between the frames 300 to be closer to the breaking roller assembly 200 than the first conveyor roller 110 is, the conveyor belt 150 surrounding the first conveyor roller 110 and the second conveyor roller 130 and having the transfer surface 150S in contact with the residual glass G_b, and the conveyor motor 170 configured to rotate at least one of the first conveyor roller 110 or the second conveyor roller 130.

Furthermore, the breaking roller assembly 200 may include the first breaking roller 210 including the breaking pin 215 and configured to rotate around the rotation axis extending in the second direction perpendicular to the first direction in which the residual glass G_b is moved, and the second breaking roller 220 arranged under the first breaking roller 210, configured to rotate in a direction opposite to the rotation direction of the first breaking roller 210, and having the accommodation groove 220G for accommodating the breaking pin 215.

Furthermore, the first breaking roller 210 may include the first rotation body 213 configured to rotate around the rotation axis and having the coupling opening 213_T extending in a direction in which the rotation axis extends, and the breaking pin 215 fit-coupled to the coupling opening 213_T of the first rotation body 213 and configured to break the residual glass G_b.

Furthermore, the second breaking roller 220 may include the second rotation body 223 configured to rotate around the rotation axis thereof and having the accommodation groove 220G for accommodating the breaking pin 215 of the first breaking roller 210.

The accommodation groove 220G may extend in a direction parallel to the direction in which the rotation axis of the second breaking roller 220 extends.

In an embodiment, the residual glass G_b may be moved in the first direction through the belt conveyor assembly 100.

In detail, the residual glass G_b may be moved toward the breaking roller assembly 200 through the belt conveyor assembly 100.

In an embodiment, the residual glass G_b may enter the space between the first breaking roller 210 and the second breaking roller 220 of the breaking roller assembly 200.

The residual glass G_b may be provided between the lower surface of the first breaking roller 210 and the upper surface of the second breaking roller 220, and the residual glass G_b may be moved in the first direction through the rotations of the first breaking roller 210 and the second breaking roller 220.

Furthermore, while the breaking roller assembly 200 moves the residual glass G_b in the first direction, the breaking roller assembly 200 may break the residual glass G_b.

In an embodiment, when the breaking pin 215 of the first breaking roller 210 is in contact with the residual glass G_b through the rotation of the first rotation body 213, the breaking pin 215 may break the residual glass G_b.

The broken glass G_c broken by the breaking roller assembly 200 may pass between the first breaking roller 210 and the second breaking roller 220 and fall downward by gravity.

The broken glass G_c may be contained in the container 700 arranged under the breaking roller assembly 200.

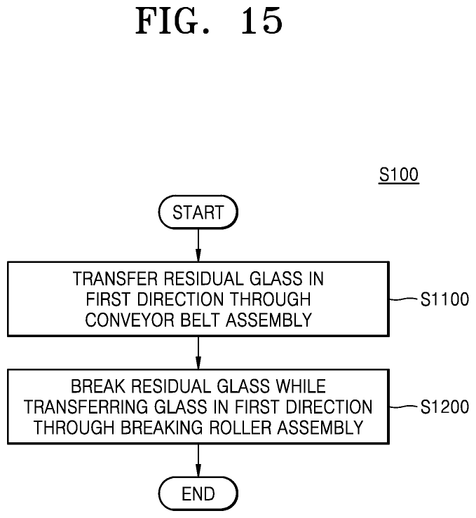

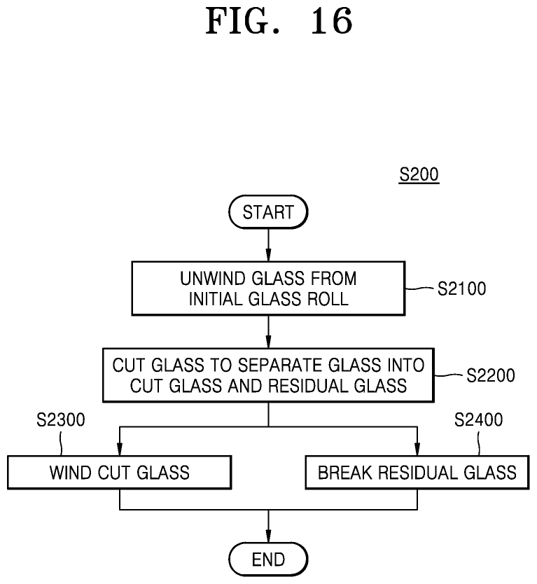

FIGS. 15 and 16 are flowcharts of glass processing methods S100 and S200 according to embodiments.

Referring to FIG. 15, the glass processing method S100 according to an embodiment may include transferring the residual glass G_b in the first direction through the belt conveyor assembly 100 (S1100), and breaking the residual glass G_b while transferring the residual glass G_b received from the belt conveyor assembly 100 in the first direction through the breaking roller assembly 200 (S1200).

In S1100, the belt conveyor assembly 100 may transfer the residual glass G_b in the first direction.

The belt conveyor assembly 100 may include the first conveyor roller 110, the second conveyor roller 130, the conveyor belt 150 surrounding the first conveyor roller 110 and the second conveyor roller 130, and the conveyor motor 170 configured to rotate at least one of the first conveyor roller 110 or the second conveyor roller 130.

In an embodiment, in S1100, the residual glass G_b placed on the transfer surface 150S of the conveyor belt 150 may be moved in the first direction by the rotations of the first conveyor roller 110 and the second conveyor roller 130.

In S1200, the breaking roller assembly 200 may be configured to break the residual glass G_b by transferring the residual glass G_b received from the belt conveyor assembly 100 in the first direction.

The breaking roller assembly 200 may include the first breaking roller 210 including the breaking pin 215 and configured to rotate in the first rotation direction, and the second breaking roller 220 having the accommodation groove 220G for accommodating the breaking pin 215 and configured to rotate in the second rotation direction opposite to the first rotation direction so that the accommodation groove 220G is engaged with the breaking pin 215.

In an embodiment, In S1200, the residual glass G_b may enter the space between the first breaking roller 210 and the second breaking roller 220.

In detail, as the first breaking roller 210 may be arranged above the transfer surface 150S of the conveyor belt 150 and the second breaking roller 220 may be arranged under the transfer surface 150S of the conveyor belt 150, the residual glass G_b may enter the space between the first breaking roller 210 and the second breaking roller 220.

In S1200, the residual glass G_b may be provided between the lower surface of the first breaking roller 210 and the upper surface of the second breaking roller 220, and the residual glass G_b may be moved in the first direction through the rotations of the first breaking roller 210 and the second breaking roller 220.

Furthermore, while the breaking roller assembly 200 moves the residual glass G_b in the first direction, the breaking roller assembly 200 may break the residual glass G_b through the breaking pin 215

Referring to FIG. 16, the glass processing method S200 according to an embodiment may include unwinding the glass G from the initial glass roll R0 (S2100), cutting the glass G to separate the glass G into the cut glass G_r and the residual glass G_b (S2200), winding the cut glass G_r (S2300), and breaking the residual glass G_b (S2400).

In S2100, the glass supply apparatus 20 may unwind the initial glass roll R0 to provide the glass G in a plate shape.

For example, In S2100, a glass unwinder configured to unwind the glass G from the initial glass roll R0 may be used.

In S2200, the glass cutting apparatus 30 may cut the glass G to separate the glass G into the cut glass G_r and the residual glass G_b.

In an embodiment, the glass cutting apparatus 30 may separate the glass G into the cut glass G_r and the residual glass G_b by using a laser beam.

The cut glass G_r may be glass for a process of forming the new glass roll R1, and the residual glass G_b may be glass for a breaking process.

In S2300, the glass winding apparatus 40 may wind the cut glass G_r to form the new glass roll R1.

Furthermore, the new glass roll R1 manufactured in S2300 may be provided to an end customer.

In S2400, the breaking roller assembly 200 may break the residual glass G_b.

The residual glass G_b broken by the breaking roller assembly 200 may be transferred into a process chamber for manufacturing new glass.

In an embodiment, operation S2400 may include transferring the residual glass G_b in the first direction through the belt conveyor assembly 100, and transferring the residual glass G_b received from the belt conveyor assembly 100 in the first direction and simultaneously breaking the residual glass G_b.

As operation S2400 is redundant to operation S1200 described with reference to FIG. 15, detailed descriptions thereof are omitted.

Therefore, the embodiments disclosed in the disclosure are intended to illustrate the scope of the technical idea of the disclosure, and the scope of the technical idea of the disclosure is not limited by the embodiments.

The protection scope of the disclosure should be construed based on the accompanying claims, and it should be construed that all of the technical ideas included within the scope equivalent to the claims are included within the right scope of the disclosure.

It should be understood that embodiments described herein should be considered in a descriptive sense only and not for purposes of limitation.

Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

1. A glass breaking apparatus comprising:
a belt conveyor assembly configured to transfer glass in a first direction; and
a breaking roller assembly configured to break the glass received from the belt conveyor assembly, the breaking roller assembly comprising:
a first breaking roller comprising a breaking pin and configured to rotate around a rotation axis extending in a second direction perpendicular to the first direction; and
a second breaking roller arranged under the first breaking roller, configured to rotate in a direction opposite to a rotation direction of the first breaking roller.

2. The glass breaking apparatus of claim 1, further comprising a plurality of frames arranged at sides of the belt conveyor assembly and the breaking roller assembly, and configured to fix the belt conveyor assembly and the breaking roller assembly.

3. The glass breaking apparatus of claim 2, wherein the belt conveyor assembly comprises:
a first conveyor roller arranged between the plurality of frames;
a second conveyor roller arranged between the plurality of frames to be closer to the breaking roller assembly that the first conveyor roller is;
a conveyor belt surrounding the first conveyor roller and the second conveyor roller and comprising a transfer surface in contact with the glass; and
a conveyor motor configured to rotate at least one of the first conveyor roller or the second conveyor roller.

4. The glass breaking apparatus of claim 3, wherein
the first breaking roller is arranged above the transfer surface of the conveyor belt,
the second breaking roller is arranged under the transfer surface of the conveyor belt, and
the first breaking roller and the second breaking roller are rotated to move the glass in the first direction, the glass passing between the first breaking roller and the second breaking roller.

5. The glass breaking apparatus of claim 1, wherein
the first breaking roller comprises a first rotation body comprising a coupling opening for fit-coupling a portion of the breaking pin, and
the coupling opening extends in a direction parallel to a direction in which a rotation axis of the first rotation body extends.

6. The glass breaking apparatus of claim 5, wherein the breaking pin comprises:
a coupling portion fit-coupled to the coupling opening of the first rotation body;
a breaking portion provided in a tapered shape such that a cross-sectional area of the breaking portion decreases as it is farther away from the coupling portion; and
a connection portion configured to connect the coupling portion to the breaking portion.

7. The glass breaking apparatus of claim 6, wherein a section of the breaking portion has at least one of a triangular shape, a trapezoidal shape, or a semi-circular shape.

8. The glass breaking apparatus of claim 6, wherein
the first rotation body of the first breaking roller comprises a fastening hole passing through at least a portion of the first rotation body in the coupling opening, and
the coupling portion of the breaking pin comprises a fastening hole overlapping the fastening hole of the first rotation body.

9. The glass breaking apparatus of claim 8, further comprising a fastening member arranged in the fastening hole of the first rotation body by passing through the fastening hole of the breaking pin, and configured to fix the breaking pin on the first rotation body.

10. The glass breaking apparatus of claim 1, wherein
the second breaking roller comprises a second rotation body comprising the accommodation groove for accommodating the breaking pin, and
the accommodation groove extends in a direction parallel to a direction in which a rotation axis of the second rotation body extends.

11. The glass breaking apparatus of claim 10, wherein the accommodation groove has a cross-sectional area that decreases closer to the rotation axis of the second rotation body.

12. The glass breaking apparatus of claim 2, further comprising:
a first gear connected to the first breaking roller and arranged outside the frame;
a second gear connected to the second breaking roller and arranged outside the frame to be engaged with the first gear;
a driving gear connected to at least one of the first gear or the second gear; and
a breaking roller motor configured to operate the driving gear.

13. A glass processing system comprising:
a glass supply apparatus configured to supply glass;
a glass cutting apparatus configured to separate the glass into cut glass and residual glass;
a glass winding apparatus configured to wind the cut glass to form a glass roll; and
a glass breaking apparatus configured to break the residual glass, the glass breaking apparatus comprising: a belt conveyor assembly configured to transfer the residual glass in a first direction; and a breaking roller assembly configured to break the residual glass received from the belt conveyor assembly,
wherein the breaking roller assembly comprises:
a first breaking roller configured to rotate around a rotation axis extending in a second direction perpendicular to the first direction, and comprising a breaking pin; and
a second breaking roller arranged under the first breaking roller, configured to rotate in a direction opposite to a rotation direction of the first breaking roller, and comprising an accommodation groove for accommodating the breaking pin.

14. The glass processing system of claim 13, wherein the glass supply apparatus comprises a glass unwinder configured to unwind the glass from an initial glass roll.

15. The glass processing system of claim 13, wherein the glass cutting apparatus comprises a laser configured to irradiate a laser beam onto the glass.

16. The glass processing system of claim 13, wherein the glass breaking apparatus further comprises a plurality of frames arranged at sides of the belt conveyor assembly and the breaking roller assembly, and configured to fix the belt conveyor assembly and the breaking roller assembly.

17. The glass processing system of claim 16, wherein the belt conveyor assembly comprises:
a first conveyor roller arranged between the plurality of frames;
a second conveyor roller arranged between the plurality of frames to be closer to the breaking roller assembly than the first conveyor roller is;
a conveyor belt surrounding the first conveyor roller and the second conveyor roller, and comprising a transfer surface in contact with the glass; and
a conveyor motor configured to rotate at least one of the first conveyor roller or the second conveyor roller.

18. The glass processing system of claim 17, wherein
the first breaking roller is arranged above the transfer surface of the conveyor belt, and
the second breaking roller is arranged under the transfer surface of the conveyor belt.

19. The glass processing system of claim 13, wherein
the first breaking roller comprises a first rotation body comprising a coupling opening for fit-coupling a portion of the breaking pin, and
the coupling opening extends in a direction parallel to a direction in which a rotation axis of the first rotation body extends.

20. The glass processing system of claim 19, wherein the breaking pin comprises:
a coupling portion fit-coupled to the coupling opening of the first rotation body;
a breaking portion provided in a tapered shape such that a cross-sectional area of the breaking portion decreases as it is farther away from the coupling portion; and
a connection portion configured to connect the coupling portion to the breaking portion.

21.-27. (canceled)
